(19) United States
(12) Patent Application Publication
(10) Pub. No.: US 2006/0143111 A1
(43) Pub. Date: Jun. 29, 2006

(54) System and method for trading spectrum rights

(75) Inventor: Darrin-Michael Mylet, Tampa, FL (US)

Correspondence Address: BAKER BOTTS L.L.P., 2001 ROSS AVENUE, SUITE 600, DALLAS, TX, 75201-2980, US

(73) Assignee: CFPH, LLC

(21) Appl. No.: 11/361,713

(22) Filed: Feb. 24, 2006

Related U.S. Application Data
(63) Continuation-in-part of application No. 10/913,727, filed on Aug. 6, 2004.

(51) Int. Cl. G06Q 40/00

(52) U.S. Cl. 705/37

(57) ABSTRACT

An exchange platform for facilitating a transaction involving spectrum assets is provided that includes a database operable to store information associated with at least one spectrum asset that includes virtual rights to be afforded to a holder of the spectrum asset. The database is further operable to communicate with an end user that provides data to the exchange platform. The database can be accessed by the end user in order to identify the spectrum asset. In more specific embodiments, the database is further operable to store information associated with at least one slot of a channel associated with the spectrum asset. Once secured, the slot can be used, for example, to broadcast content at a designated time interval to a subscribing audience.

### RELATED APPLICATION

This application claims priority to, and is a continuation-in-part of, U.S. application Ser. No. 10/913,727 entitled “SYSTEM AND METHOD FOR TRADING WIRELESS SPECTRUM RIGHTS” filed Aug. 6, 2004.

### TECHNICAL FIELD OF THE INVENTION

This invention relates in general to trading and, more particularly, to a system and method for trading spectrum rights.

### BACKGROUND OF THE INVENTION

The electromagnetic spectrum is as old as the universe. However, based on recent attention and news coverage, people could easily be led to believe that it had just surfaced yesterday. The term “spectrum” simply connotes the range of electromagnetic radiation, from the highest frequency to the lowest. It encompasses everything from X-rays and gamma rays to visible light and radio waves. The part of the spectrum used for cell phones, broadcasting, satellites, and other wireless communications falls in the range of fairly low radio frequencies (i.e. from about 3 KHz up to about 300 GHz) Most of the major commercial activity occurs between 30 MHz to 30 GHz. Frequencies higher than 300 GHz lead to infrared radiation, visible light, ultraviolet light, X-rays, and gamma rays.

New digital and wireless technologies, inclusive of cell phones, satellites, and high-definition television, are dramatically changing how people use the airwaves. In response to this dramatic shift, incredible new business opportunities are being presented. The United States government and the Federal Communications Commission (FCC) have responded to the shift in ideology by reallocating huge segments of the spectrum for new uses and by auctioning slices of the electromagnetic spectrum to the highest bidders. In 1993, Congress authorized the FCC to sell parts of the radio spectrum at auction.

Hence, different frequencies may be auctioned to a pool of willing bidders. These frequencies generally range from very low to very high, with each individual frequency band having unique characteristics that may be beneficial to a certain group of end users and, thus, attractive to specific business owners and entrepreneurs based on their respective technologies. For a particular spectrum, such acquisitions may fetch prices in the billions. The delicate future for many telecommunications companies rests on the outcome of those auctions.

For all the potential dangers lurking in the maze of confusion surrounding spectrum auctions, an efficient marketplace for spectrum is yet to develop. Errors in judgment, in the context of pricing, purchasing, leasing, and selling spectrum rights, could cause any given company to endure financial ruin. In any successful marketplace, there needs to be enough buyers and enough sellers to energize the marketplace such that the marketplace offers a fair exchange of any asset. Moreover, an accurate pricing and description of any commodity represents the crux of fair dealing and equitable results for both buyers and sellers alike.

Accordingly, the ability to provide an efficient wireless spectrum marketplace that accommodates the needs of buyers and sellers presents a significant challenge.

### SUMMARY OF THE INVENTION

From the foregoing, it may be appreciated by those skilled in the art that a need has arisen for an improved spectrum exchange platform that provides for enhanced liquidity, asset descriptions, and diversification for participants. In accordance with an embodiment of the present invention, a system and a method for offering a platform for one or more wireless spectrum and towers (or tower space on towers) transactions to be executed in an auction or market environment are provided that substantially eliminate or greatly reduce disadvantages and problems associated with conventional exchange approaches and instruments.

According to an embodiment of the present invention, a method for facilitating a transaction involving spectrum assets, towers, or tower space allocations is provided that includes storing information associated with at least one wireless spectrum asset in a database and communicating with an end user that provides data. The database can be accessed by the end user in order to identify the wireless spectrum asset.

In a more particular embodiment, the method may further include utilizing the data communicated by the end user in a registration process. The registration process can be used to ascertain whether the end user is a qualified participant in a transaction involving wireless spectrum as determined by the Federal Communications Commission (FCC) or other regulatory agencies. The method may further include facilitating a transaction involving the selected wireless spectrum asset or the selected tower space allocation, the transaction involving a lease, a sale, a transfer, or a purchase of the selected wireless spectrum asset or the selected towers or tower space allocations. The end user may be a selected one of a buyer, a seller, or a leaser of the selected spectrum asset or the selected tower or tower space allocation.

In another embodiment, an exchange platform for facilitating a transaction involving spectrum assets is provided that includes a database operable to store information associated with at least one spectrum asset that includes virtual rights to be afforded to a holder of the spectrum asset. The database is further operable to communicate with an end user that provides data to the exchange platform. The database can be accessed by the end user in order to identify the spectrum asset. In more specific embodiments, the database is further operable to store information associated with at least one slot of a channel associated with the spectrum asset. Once secured, the slot can be used, for example, to broadcast content at a designated time interval to a subscribing audience.

Certain embodiments of the present invention may provide a number of technical advantages. For example, according to one embodiment of the present invention, an exchange platform is provided that includes a database, which (preferably) can aggregate the components of the marketplace into a single element that greatly expedites and facilitates the trading of spectrum between buyers and sellers. The database further offers a mechanism to verify the quality and availability of spectrum, to facilitate the identification of qualified parties who wish to engage in a transaction, to permit negotiation of the terms and conditions with respect to price and term, and to facilitate electronic consummation of key economic considerations. Thus, such an architecture can consolidate a number of time-intensive tasks into a single powerful wireless spectrum tool that automates such arduous chores. Moreover, such a tool informs a prospective buyer or seller about any pertinent transactional information. This could include simple asset descriptions or the ability to identify owners of particular spectrum in a chosen area. Other capabilities are readily accommodated by the present invention and described below in greater detail.

The present invention brings together a comprehensive database of available inventory: offering complete granularity for buyers and sellers. The database could also include a comprehensive list of qualified participants. The database can further be used in order to facilitate and expedite real-time communications between all qualified participants, as well as provide verifiable documentation of all communications, while assisting in the regulatory approval process. This may be achieved through the creation of first-stage legal documents as addenda and through framework exhibits to final contracts. Thus, the proffered architecture offers a host of improved capabilities for any person or company actively engaged in any transaction associated with tower space or wireless spectrum.

Certain embodiments of the present invention may enjoy some, all, or none of these advantages. Other technical advantages may be readily apparent to one skilled in the art from the following figures, description, and claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a simplified block diagram of a system for facilitating a wireless spectrum or a tower/tower space transaction in a marketplace environment in accordance with an embodiment of the present invention;

FIG. 2 is a simplified schematic diagram of an example registration page that may be used in the system;

FIG. 3 is a simplified schematic diagram of an example log-in page that may be used in the system;

FIG. 4 is a simplified schematic diagram of an example transaction page that may be used in the system;

FIG. 5 is a simplified schematic diagram of an example asset description page that may be used in the system;

FIG. 6 is a simplified schematic diagram of an example frequency selection page that may be used in the system;

FIG. 7 is a simplified schematic diagram of an example mapping pages that may be used in the system;

FIGS. 8A and 8B are simplified schematic diagrams of more detailed example mapping pages that may be used in the system;

FIG. 9 is a simplified schematic diagram of an example auction parameter page that may be used in the system;

FIG. 10 is a simplified schematic diagram of an example offerings selection page that may be used in the system;

FIG. 11 is a simplified schematic diagram of an example trade submission and/or approval page that may be used in the system;

FIG. 12 is a simplified schematic diagram of an example offerings page that may be used in the system;

FIG. 13 is a simplified schematic diagram of an example completion page that may be used in the system; and

FIG. 14 is a simplified schematic diagram that can be used to describe another implementation of the present invention.

### DETAILED DESCRIPTION

For purposes of teaching and discussion, it is useful to provide some overview as to the way in which the following invention operates. The following foundational information may be viewed as a basis from which the present invention may be properly explained. Such information is offered earnestly for purposes of explanation and discussion only and, accordingly, should not be construed in any way to limit the broad scope of the present invention and its potential applications.

Technically, airwaves are a natural resource. In practice, they are controlled by any number of national governments. The Federal Communications Commission (FCC) (or other regulatory bodies such as, e.g., the European Union (EU) or the Office of Communications (Ofcom)) grants licenses (i.e. spectrum use rights) for companies to use specific chunks of spectrum in specific geographic areas, and, usually, only in specific ways. For example, the FCC can revoke a license it feels is not being used in accordance with the agency's rules. The U.S. federal government used to distribute licenses for free in a lottery system, but then it was discovered that companies were later selling the licenses for excessive sums. Hence, the idea to auction them was developed. Cantor Fitzgerald technology (i.e. a rudimentary and simplistic model) was used in the FCC's first auctions of personal communications services (PCS) spectrum in the 1990's.

Individuals are generally provided the opportunity to purchase a certain frequency in primary or secondary markets. Physics generally dictates a few general rules about spectrum that determine what kind of services companies can offer and, further, the cost of building a network. Along with the purchase of the particular frequency being auctioned comes the rights to use that frequency.

In current systems, spectrum rights can be sold to another person. For example, if a person owned a certain spectrum in San Jose, Calif. (e.g., 1900 MHz), those rights could be transferred to another person: provided that such a person was a qualified buyer as determined by FCC regulations. Recently, the FCC has expanded the ability to transfer spectrum rights. Hence, under existing protocols, the FCC authorizes the leasing of spectrum rights from one party to another. Leasing provides a viable option to an owner of spectrum rights who is unable to maximize utilization of the frequency band, or who cannot (most likely based on his financial resources) use the spectrum at all. Thus, leasing gives an owner of spectrum rights flexibility in being able to temporarily transfer his rights to a third party for a payment. Perhaps over the ensuing five or ten years, the original owner of the spectrum rights may become more financially stable such that he is able to resume control over the spectrum before the lease expires and the spectrum is re-auctioned (in the secondary market, not the FCC auction).

In existing systems today, most of the frequencies are purchased by ‘specialists.’ Specialists generally broker deals or transact business associated with a selected spectrum (e.g., a 1900 MHz specialist, a 2.5 GHz specialist, etc.). In response to these conditions, a ‘specialists marketplace’ has emerged: a marketplace that has a number of deficiencies and drawbacks. For example, such a marketplace is not efficient, as it is difficult to ascertain whether or not a person is paying fair value for a given spectrum. Moreover, there is a limited number of participating buyers or sellers. As can be readily appreciated by any individual who understands simple marketplace dynamics, a limited supply of buyers and sellers often produces illiquidity constraints, improper pricing of commodities being sold, and misguided expectations about future spectrum market conditions. Such an environment has a propensity to foster speculation, to promote hedging, and to inhibit overall stability in the marketplace.

As the telecommunications industry begins to rebound from the tech bubble of 1999-2000, these problems in the current marketplace become more salient. Currently, a large number of individuals are actively seeking to purchase certain spectrum rights. Many such individuals need access to wireless frequencies in order to accommodate their business needs. In other, potentially less popular frequencies, individuals are still clamoring to purchase spectrum rights that can be used as a basis for their underlying business models.

If a random poll were taken today that solicited the opinions of local governments, municipalities, internet service providers, wireless providers, and telephone companies about how to purchase spectrum rights, probably no two entities would offer the same answer. The diversity in responses is because there is not a consensus about pricing, marketplace environments, and liquidity parameters associated with the sale, purchase, or leasing of spectrum rights. Stated more succinctly: there is no central efficient marketplace to execute such transactions.

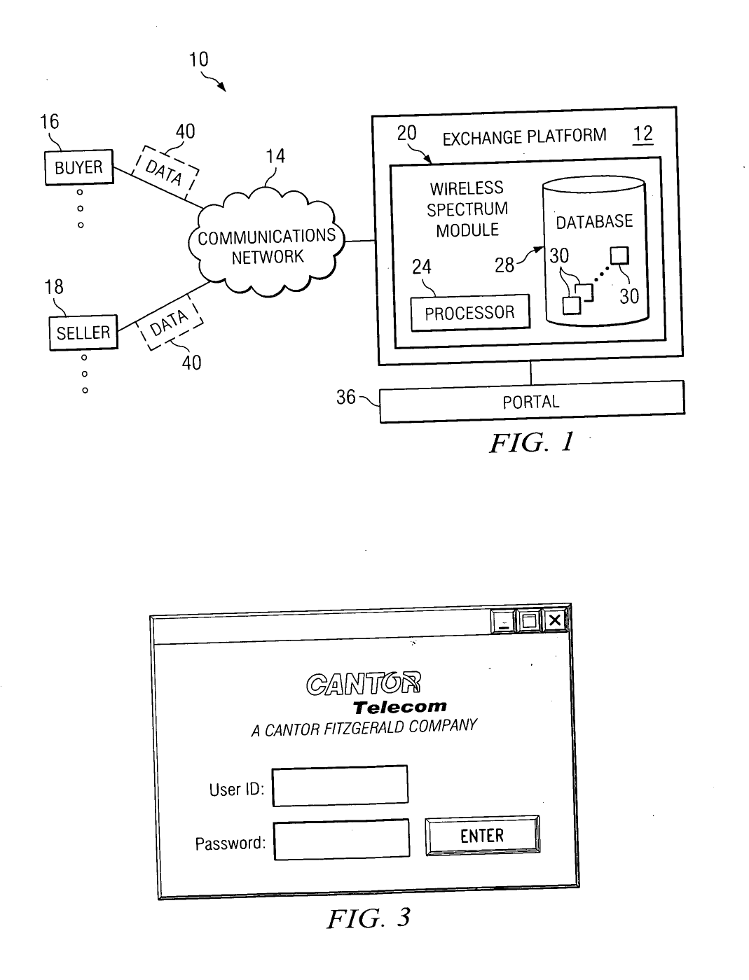

The architecture of the present invention addresses these issues by providing a marketplace for buyers and sellers to transact their spectrum right deals in an optimal fashion. The proffered architecture is described more fully below with reference to FIGS. 1-14.

FIG. 1 is a simplified block diagram of a system 10 for executing one or more wireless spectrum transactions in an auction/market environment. System 10 comprises an exchange platform 12, a communications network 14, a buyer 16, and a seller 18. Exchange platform 12 may include a wireless spectrum module 20. Wireless spectrum module 20 may include a processor 24 and a database 28, which may store one or more profiles 30 associated with buyers 16 and sellers 18. Exchange platform 12 may be coupled to a portal 36, which could provide a communication link to any suitable entity for database accuracy, monitoring functions, or record keeping as explained more fully below.

Any individual who is confronted with an issue that involves the use of spectrum rights, towers, or tower space allocations could readily access the spectrum exchange offered by system 10 in order to address his issue. The architecture would allow the individual to immediately identify the availability of a given spectrum in a selected location and, further, to recognize an associated price estimate for the targeted spectrum. Moreover, such a person could readily identify a supply of willing sellers and (potentially) bidders for any available spectrum. Thus, any given individual that is interested in buying, selling, transferring or leasing spectrum rights (and/or towers and tower rights (inclusive of tower space)) could access system 10 in order to address their specific spectrum right endeavors. Bidding associated with the provided architecture could be provided with an indication of “interest” and “firm commitment,” the latter of which may be generally supported by suitable financial backing, as explained more fully below.

In operation of an example embodiment used for purposes of teaching and discussion only, system 10 offers a configuration that both facilitates and expedites transactions to buy, sell, lease, transfer (inclusive of swaps) and utilize wireless spectrum. This may be achieved by using database 28, which offers a searchable, comprehensive listing of physical inventory. Moreover, the data retrieved from database 28 is capable of facilitating real-time electronic negotiations between buyer 16 and seller 18. Thus, exchange platform 12 may verify buyer and seller information in order to determine whether each individual is qualified and authorized to participate in such an endeavor. During this registration process, one or more profiles 30 are generated for each buyer 16 and seller 18.

Exchange platform 12 (in cooperation with database 28) may also offer accurate pricing for spectrum assets and provide any terms and conditions documents for spectrum rights for the associated transaction. Using one or more of the provided components, system 10 can facilitate formation of an electronic agreement, acceptance from both parties, and execution of the transaction terms. Concurrently, system 10 is capable of performing auditing functions (with respect to incoming and outgoing data) in order to record information that can fulfill streamlined regulatory compliance requirements as promulgated by the FCC.

System 10 provides an open and neutral exchange for facilitating the transfer of any commodity associated with spectrum rights or tower space locations. System 10 offers a true intermediary that offers equal and bipartisan opportunities for all participating individuals to achieve beneficial results. This is because the operator of system 10 would generally take no ownership interest in the underlying spectrum rights and, therefore, is insulated from any pressure to influence any outcome associated with the transactions. Such impartiality stands in stark contrast to other regimes in which consultants (working for large telephone companies) exert significant pressure on any given transaction in order to affect a deal that is remunerative for their own party. Such influential groups can become even more powerful in cases where a group dynamic is achieved in order to leverage a particular party in comparison to another participant in the deal. System 10 avoids all such unfair dealings, as an unbiased and an evenhanded marketplace is provided for all auction participants.

System 10 may also assist in the completion of contractual terms and conditions for regulatory submission and approval. The right of the qualified participants in the electronic exchange to investigate commercial opportunities and/or assess the economic value of assets held in inventory (via database 28) may be achieved. Buyers 16 and sellers 18 are also afforded the opportunity to execute commercial transactions in a timely and reliable manner. Furthermore, the characteristics of the marketplace offered by system 10 meet the FCC standard that requires that marketplace structures, practices, and disclosures be fair, transparent, and effective.

Exchange platform 12 is a trading architecture that facilitates the purchase, lease, and sale of one or more spectrum or tower space transactions. In one example embodiment, exchange platform 12 is a website and/or a server that allows access for buyer 16 or seller 18 to conduct one or more transactions associated with wireless spectrum or towers or tower space. Note that as used herein in this document the term “tower space allocation” is inclusive of outright purchases of an entire tower, as well as simple tower space transactions. Exchange platform 12 is operable to receive and to process requests associated with transactions involving buyers 16 and sellers 18. In other embodiments, exchange platform 12 may be a single network node (that includes database 28 only) or a single computer, a management center, a single workstation, or a headquartering office for any person, business, or entity that seeks to manage the purchase, leasing, sale, transfer, or trading of spectrum or tower rights. Accordingly, exchange platform 12 may include any suitable hardware, software, personnel, devices, components, elements, or objects that may be utilized or implemented to achieve the operations and functions of an administrative body or a supervising entity that manages or administers a marketplace environment.

Exchange platform 12 may be owned and operated by any suitable entity having the authority to operate in the exchange of spectrum or tower rights. A connection may be present between exchange platform 12 and any other relevant exchange, whereby information associated with any transaction that is proposed by buyer 16 or seller 18 is relayed to an appropriate exchange to consummate the transaction (e.g., portal 36). Thus, exchange platform 12 may operate as a proxy between buyer 16/seller 18 (or between any other third party) and a corresponding exchange that can record and confirm a tendered purchase or sale of wireless spectrum or tower asset. Alternatively and where authorized, exchange platform 12 may perform such trade execution functions independently.

Exchange platform 12 may also deliver real-time financial data to buyer 16 or seller 18 in order to provide pertinent financial information to be used to make decisions as to whether to purchase or to sell various assets. This relay of financial information may be performed via database 28 or via any other suitable external element. Data, such as pricing information, asset class, maturity data, historical quotes, or current owners of spectrum, for example, may be provided to buyer 16 and seller 18. Other financial data may also be readily delivered and based on particular needs.

Note that exchange platform 12 is in full compliance with current FCC protocols such that current FCC auction processes can readily be accommodated by system 10. The FCC generally uses a simultaneous multiple-round (SMR) auction for wireless spectrum rights, whereby all licenses are available for bidding throughout the entire auction (thus, the term “simultaneous”). Unlike most auctions in which bidding is continuous, SMR auctions have discrete, successive rounds, with the length of each round announced in advance by the FCC.

After each round closes, round results are processed and made public. Only then do buyers 16 learn about the bids placed by other buyers 16. This provides information about the value of the licenses to all bidders and increases the likelihood that the licenses will be assigned to the bidders who value them the most. The period between auction rounds also allows bidders to take stock of, and perhaps adjust, their bidding strategies.

In an SMR auction, there is no preset number of rounds. Bidding continues, round after round, until a round occurs in which all bidder activity ceases, whereby that round becomes the closing round of the auction. The FCC's SMR auction design can be modified to allow combinatorial or “package” bidding. In the case of package bidding, bidders may place bids on groups of licenses as well as on individual licenses. This approach allows bidders to better express the value of any synergies (i.e. benefits from combining complementary items) that may exist among licenses and to avoid the risk of winning only part of a desired set.

Communications network 14 is a communicative platform operable to exchange data or information between buyer 16/seller 18 and exchange platform 12. Communications network 14 represents an Internet architecture in a particular embodiment of the present invention, which provides buyer 16 or seller 18 with the ability to electronically execute trades or initiate transactions to be delivered to exchange platform 12. Alternatively, communications network 14 could be a plain old telephone system (POTS), which buyer 16 or seller 18 could use to perform the same operations or functions. Such transactions may be assisted by a representative or a broker associated with exchange platform 12, or manually keyed into a telephone or other suitable electronic equipment in order to request that a transaction be initiated or executed.

In other embodiments, communications system 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In an alternative embodiment, communications network 14 and/or wireless spectrum module 20 may be replaced entirely or partially with a person, providing a human interface to a corresponding trading platform. In such an embodiment, an agent of exchange platform 12 or any other suitable person or representative may be contacted by buyer 16 or seller 18 (e.g., via the telephone, a network, other suitable electronic equipment, or directly by word of mouth). The agent or representative may receive a request from buyer 16 or seller 18 to execute some transaction involving spectrum or tower rights. The agent or representative may then record the transaction once it has been consummated and contact buyer 16 or seller 18 to confirm that the transaction has been executed.

Buyer 16 and seller 18 are end users: representative of clients, customers, prospective investors, or entities wishing to access or to initiate a communication with exchange platform 12 to be delivered via communications network 14. Alternatively, buyer 16 and seller 18 may represent any device or object that seeks to initiate a communication on behalf of another entity or element, such as a program, a database, or any other component, device, element, or object capable of initiating a voice or a data exchange within system 10. Data 40, as used herein in this document, refers to any type of numeric, voice, video, or script data, or any other suitable information in any appropriate format that is associated with any element relating to spectrum or tower rights. Data 40 that propagates between buyer 16 or seller 18 and exchange platform 12 (via communications network 14) establishes a communications flow. Such a communications flow could be a simple request for information (e.g., an asset search request involving database 28), a bid on an asset, an offer to sell an asset, profile information, FCC documents, contract terms, or any other suitable data segment associated with activities related to system 10. In an example embodiment, buyer 16 and seller 18 are investors interested in purchasing or selling wireless spectrum rights. Buyer 16 and seller 18 may also be simply seeking to review performance characteristics of wireless assets included in database 28 or to ascertain specific details relating to the assets contained therein.

Note that FCC auctions are open to any eligible company or individual (such as buyer 16 or seller 18) that submits an application, an upfront payment, and is found to be a qualified bidder by the FCC. FCC auctions are conducted electronically and are accessible over the Internet. Thus, qualified bidders can place bids from the comfort of their home or office. Further, anyone with access to a computer with a web browser can follow the progress of an auction and view the results of each round.

Buyers 16 or sellers 18 are qualified participants (as mandated by the FCC) in an example embodiment. The FCC requires that, in addition to filing an FCC Form 175 application, each buyer 16 or seller 18 must submit an upfront payment, which is a refundable deposit toward the bids they plan to make in the auction. Prior to an FCC auction, each license being auctioned is assigned a specific number of bidding units, and the upfront payment is used to buy the right to bid on those bidding units.

Buyer 16 or seller 18 does not need to submit an upfront payment for each license specified in its Form 175. Instead, an applicant must only submit an upfront payment that will purchase the maximum number of bidding units on which it will wish to bid (including any standing high bids) in any single round. For example, an applicant may list five licenses in its Form 175, but only plan to bid on two of those licenses in any one round. That applicant could then submit an upfront payment that covers the bidding units for those two licenses.

Buyer 16 and seller 18 may each be provided with an end user interface comprising a central processing unit (CPU). The end user interface may be employed by either buyer 16 or seller 18 in order to initiate transactions or to perform asset-monitoring functions within system 10. Alternatively, such an end user interface may be replaced with any other suitable interface or object that facilitates communications between buyer 16, seller 18, and any other element within system 10, such as: a cellular telephone, an electronic notebook, a personal digital assistant (PDA), or any other suitable device (wireless or otherwise), component, or element capable of accessing one or more elements within system 10. The end user interface may also comprise any suitable interface for a human user such as a display, a microphone, a keyboard, or any other appropriate terminal equipment according to particular configurations and arrangements. In addition, the end user interface may be a unique element designed specifically for communications involving the purchase, sale, or lease of spectrum or tower rights. Such an element may be fabricated or produced specifically for wireless spectrum applications involving buyer 16 and seller 18.

Wireless spectrum module 20 includes processor 24 and database 28 in accordance with one example embodiment of the present invention. Wireless spectrum module 20 is operable to receive requests (i.e. data 40) from buyer 16 or seller 18 and to process those requests such that financial transactions involving selected assets may be performed. Such processing may be executed by processor 24, which is a standard central processing unit (CPU) in an example embodiment. Wireless spectrum module 20 may have a link or a connection to portal 36 such that the FCC can perform monitoring and/or approval operations in system 10. In addition, portal 36 may be used to expedite the handling of one or more transactions involving buyer 16 or seller 18.

Therefore, exchange platform 12 may be used as a liaison to the FCC (i.e. one or more end users can access the exchange in order to be connected to the FCC website). However, in other embodiments, the FCC could readily implement the offered architecture as part of their own protocol. Moreover, the FCC could further regulate this industry by requiring that individuals meet certain threshold criteria in their first year of operation. For example, one problem associated with current spectrum arrangements is that spectrums universally die. This can be due to the fact that many buyers over-extend themselves or simply lose funding for the infrastructure that was to be used to exploit the purchased spectrum to its fullest capacity. When the necessary funding is lost, the spectrum is considered dead until the spectrum is resold to another, more financially capable, individual. However, such a resale may not transpire for a number of years. During the interim, the spectrum remains inactive and underutilized. The FCC could address this dilemma by implementing system 10 and by providing regulations that require a certain purchaser to use the spectrum at a certain utilization level within a given time period.

Consider an example in which a purchaser purchased 1900 MHz band spectrum rights, which extend over the next ten years. This individual may be required to begin using the 1900 MHz (in a non-trivial manner) within eighteen months of purchase. If no activity commences during that time, the FCC could intervene and auction off a portion of those rights to individuals more capable of using the 1900 MHz spectrum. This would encourage rapid deployment of services and, further, foster competition amongst telecommunications companies. This would offer an environment that facilitates optimal usage of spectrum rights.

Database 28 is a storage element that is operable to store data and to conduct one or more searches associated with a given wireless spectrum or tower asset. Database 28 facilitates the timely discovery of resource availability and its associated price. This, in turn, creates a liquid secondary market that offers clarity to industry participants and investors (including government participants). Preferably, the tools to facilitate greater liquidity in trading of wireless spectrum would permit all market participants to act in a timely manner to acquire assets or to sell assets under a variety of market conditions.

Database 28 includes one or more profiles 30 associated with any participant associated with a transaction relating to wireless spectrum rights or tower rights. Profiles 30 may be created and maintained after retrieving the required information from buyers 16 and sellers 18. Any number of suitable variables may be included in profile 30 and be solicited at any appropriate time (e.g., via the registration which is detailed more fully in the following FIGURES). This would allow one or more end users to be properly authenticated and authorized before being allowed to participate in the marketplace. Database 28 may also include any number of addition capabilities that assist buyer 16 or seller 18 in making decisions involving the targeted assets.

For example, database 28 unites informed buyer 16 and sellers 18 by offering a component that allows for a visual (via suitable graphics as illustrated in the subsequent FIGURES) and a textual description of the assets that have been identified. In addition, database 28 may include any suitable characteristics that would influence a given decision. For example, the database could include items such as: how many cars drive by a given tower each day, the demographics associated with end users of the tower or spectrum, or any other suitable parameter or trait that could be useful or helpful in making a decision to purchase, to lease, or to sell an asset in the chosen spectrum. Third parties may be used in this endeavor, for example FAA, FCC, etc., in collecting information pertinent to market participants.

Database 28 may readily offer searching capabilities for any asset associated with wireless spectrum or tower space transactions. The availability of the assets, together with an instant voice or electronic communication method and an accurate determination of the prices for those assets, are the necessary components to ensure an efficient operation of exchange platform 12.

Any number of resultants (generated within or external to exchange platform 12) may be suitably stored in database 28. Processor 24 may also assist in processing any financial terms or conditions requested by buyer 16 or seller 18. In cases where wireless spectrum module 20 is unable to match the requested financial parameters or tendered contract terms provided by buyer 16 or seller 18 with that which is available in the market place, wireless spectrum module 20 may contact buyer 16 or seller 18 and notify either of the circumstances surrounding the inability to fulfill such an order.

Database 28 could also be used as a proverbial clearing house such that trades executed with exchange platform 12 could be duly logged and recorded. Moreover, database 28 could serve as a clearing house for the FCC (or for any other regulatory agency), offering a holder of record for such agencies. This may include the receipt of appropriate funds associated with any transaction. Information relating to third party transactions could also be included in database 28. Thus, database 28 (autonomously or with cooperation with portal 36 which potentially offers connecting to any number of entities) can perform monitoring functions associated with any suitable transactions (potentially external to exchange platform 12). In this sense, the present architecture can perform harvesting, storing, and monitoring functions in order to provide enhanced features and capabilities for the benefit of an end user or for the benefit of any regulatory agency.

Exchange platform 12 (through database 28) may aggregate the components of the marketplace into a single element that greatly expedites and facilitates the trading of spectrum between buyers 16 and sellers 18. Database 28 further offers a mechanism to qualify the participating parties, to verify the quality and the availability of spectrum, to facilitate the identification of qualified parties who wish to engage in a transaction, to permit negotiation of the terms and conditions with respect to price and term, and to facilitate timely electronic consummation of key economic considerations. Database 28 can execute these operations while generating preliminary legal documents in anticipation of final regulatory submission, compliance, and approval.

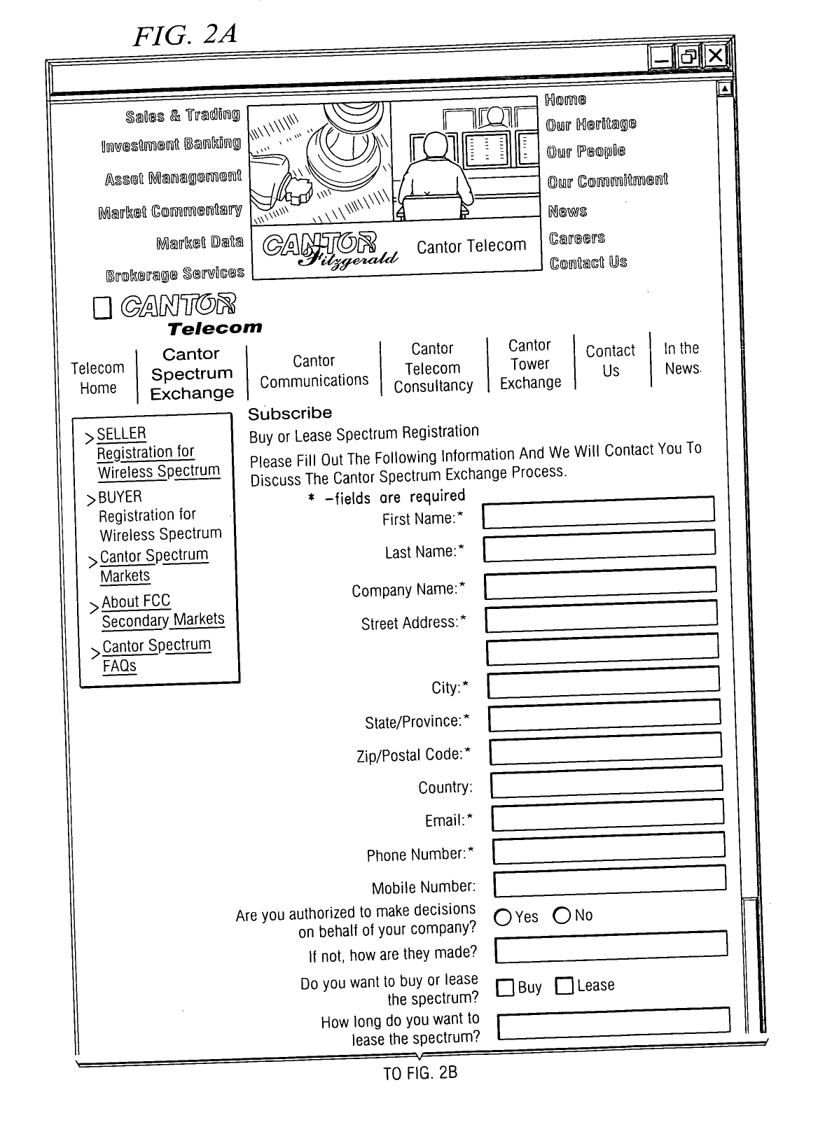

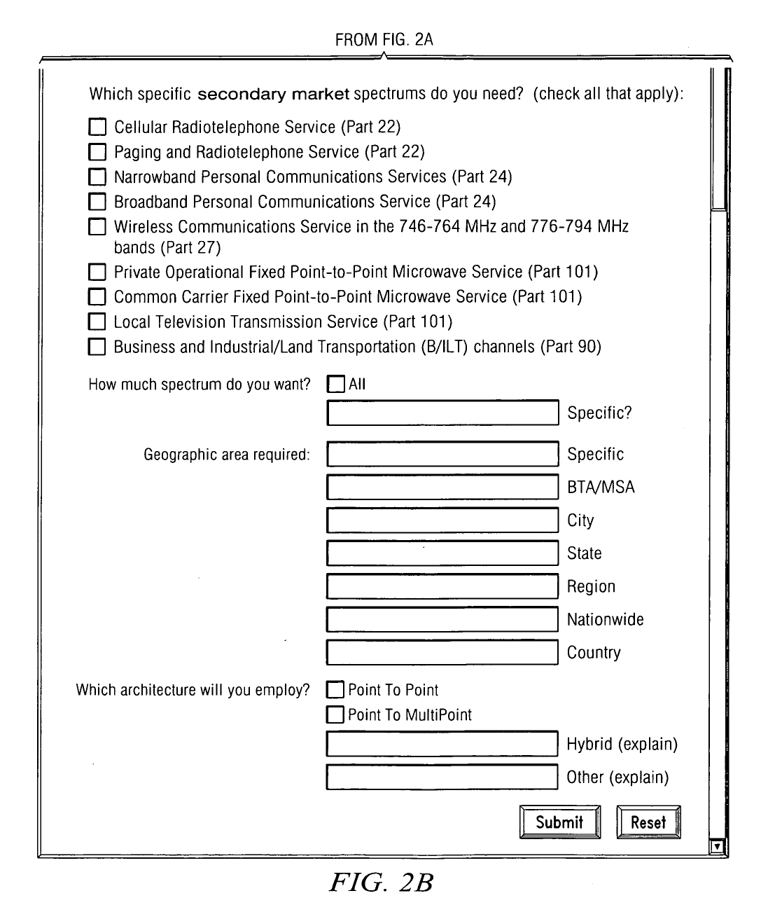

In addition, database 28 ensures a thorough and an accurate completion of electronic tasks associated with exchange platform 12. Thus, the comprehensiveness of database 28 offers a fail-safe mechanism that prohibits further progression through the various steps of the transaction process (as described more fully below with reference to FIGS. 2-14) before the previous step is fully completed. A number of redirection mechanisms (e.g., pop-up messages or simple text signaling) ensure that an end user accomplishes the designated step before proceeding to the subsequent step. Risk and uncertainty associated with deficient information collection practices is thereby ameliorated for participating parties. Hence, fears and concerns are suggested by the precision and superior performance of database 28.

Note that the existence of an electronic secondary marketplace, as provided by database 28 (which is equally operable to function in any number of primary marketplace transactions), would also facilitate the resale of secondary lease rights by struggling entities: returning underutilized and valuable spectrum to the commercial markets. Such an operation could be performed while ensuring that the seller and the buyer of the selected spectrum benefit from best market practices in determining the price for the spectrum sale. Database 28 provides for the integration of a physical geographical map and the current availability of spectrum into a single unit. This single instrument may then be used to facilitate and to expedite identification of price and, further, to execute the resulting transaction. Further, this would permit parties to the transactions to enjoy confidence in knowing that they have the best available information about their specific transactions. This could not only apply to the physical location of inventory, but this could also apply to the current prices for that inventory. This may, in turn, facilitate ongoing valuations of inventory and the recognition of additional commercial opportunities triggered by fluctuations in the value of rights held in inventory.

In the context of bankruptcy, system 10 also provides a viable alternative to simply allowing stagnating spectrum right assets to remain on the books of struggling companies, while other assets are lost through the bankruptcy proceeding. Often times, during the course of bankruptcy (or in the course of acquiring more spectrum than can be built out or used), spectrum rights are withheld and maintained (e.g., in the cases of XO Communications and Nextwave Telecom, the latter of which specializes in PCS and local multipoint distribution system (LMDS) spectrums). These companies may have little to no intent in using these spectrums or in building a telecommunications infrastructure to utilize their spectrum rights. Once these companies emerge from bankruptcy proceedings, their spectrum ownership and associated rights are worth little to their own businesses, as they cannot provide the necessary facilities to address the marketplace for these spectrum rights. Further, all spectrum holders have great incentive to build out or to lease due to time restraints set at auction for spectrum use. System 10 alleviates these problems, and offers an alternative pathway for such ailing companies. In addition, a fully operational spectrum rights exchange offers the ability to liquidate spectrum rights during the bankruptcy process or to simply lease spectrum rights quickly as companies emerge from bankruptcy.

Note that database 28 of system 10 could also be used to identify owners of certain spectrums. For example, if an individual would like to ascertain the rightful owner of the 1900 MHz slice of the spectrum in Las Vegas, Nev. database 28 could easily be searched in order to identify this information. Before the implementation of the present configuration, such an inquiry would be a complex and an arduous task. Database 28, therefore, offers an effective tool for mapping any given location to its owner and, further, his corresponding rights. For example, a simple search could reveal that the owner of the 1900 MHz range in Las Vegas, Nev. is a small businessman who is merely leasing these spectrum rights from the Sprint Corporation. Furthermore, the search could disclose that Sprint's underlying interest in the spectrum rights is going to expire concurrently with the expiration of the current lease. Thus, the inquiring individual could determine when such rights were (most likely) to be auctioned and be a participant in such a scenario.

It should be noted that the internal structure of wireless spectrum module 20 is malleable and can be readily changed, modified, rearranged, or reconfigured in order to achieve its intended operations. Accordingly, wireless spectrum module 20 (or any of the elements included therein such as database 28 or processor 24) may include any suitable component, device, application specific integrated circuit (ASIC), field-programmable gate array (FPGA), micro-processor, hardware, software, micro-processor, algorithm, read only memory (ROM) element, random access memory (RAM) element, erasable programmable ROM (EPROM), electrically erasable programmable ROM (EEPROM), or any other suitable object that is operable to facilitate the operations of wireless spectrum module 20. Considerable flexibility is provided by the structure of wireless spectrum module 20 in the context of system 10. In other embodiments, processor 24 may be included within database 28 or some of the functions of processor 24 may readily be performed by database 28 or vice versa. Thus, processor 24 can assist database 28 in its operations or perform these functions independently. In still other embodiments, wireless module 20 is simply a network node that includes database 28 and/or processor 24.

It should also be duly noted that system 10 achieves a number of beneficial results and technical effects in the context of its operations. For example, exchange platform 12 is far simpler to use than existing systems. More specifically, database 28 avoids time-intensive operations that would otherwise be performed by buyer 16 and/or seller 18 in searching for specific assets and/or commodities in hopes of executing a wireless or a tower related transaction. Moreover, the preferred functions of exchange platform 12 provide a “one stop” architecture that addresses all of the needs of buyer 16 or seller 18 at a single location. This processing at a single location further alleviates burdens placed on buyers 16 and sellers 18 and expedites all transactions in an efficient manner. Being capable of full compliance with FCC (or other governmental) regulations, system 10 offers a proverbial ‘perfect solution’ for any party engaged in such endeavors.

Portal 36 is an element that cooperates with exchange platform 12 in order to ensure a fair and a proper execution of transactions and trades initiated by buyer 16 or seller 18. Portal 36 could lead to an officer of the appropriate regulatory agency (e.g., the FCC, Ofcom, the EU, etc.) intervening at some point of the transaction (e.g., for purposes of approving or rejecting bids or offers for sale or purchase). Exchange platform 12 may conduct business in accordance with FCC rules and regulations as outlined herein in this document. Note that portal 36 could also provide additional access to other websites or databases that offer information that may be relevant to end users of exchange platform 12. Such websites could include, for example, the federal aviation administration (FAA), which could offer data pertinent to tower space assets. Portal 36 could be associated with any appropriate regulatory agency or be associated with propriety databases where appropriate.

Note that depending on the auction design, number of bidders, and the number of licenses being offered, an auction might run anywhere from one day to several weeks. Auctions are typically conducted Monday through Friday during normal business hours (Eastern Time). The first day of an auction generally opens with long bidding periods, typically two bidding rounds lasting one or two hours each, followed by round results. As the auction continues, the FCC generally increases the number of rounds per day and decreases the duration of the rounds. Bidders drop out of the auction when licenses in which they are interested exceed the value they are willing to pay. The auction typically continues until all bidding activity stops.

Note that purchasing any form of spectrum rights (for 5 years, 12 months, etc.), is a significant investment of money, which requires an exceptional appreciation for the various concurrent issues that accompany such an extraordinary purchase. Moreover, for the unwary, such an asset could present any number of potential financial predicaments. Unlike purchasing a car or a house, the purchase of spectrum should be planned, plotted, and validated before individuals should actually execute the targeted acquisition. Once the spectrum has been purchased, a company must then construct a network and an infrastructure to utilize the spectrum. Thus, any spectrum commodity represents a complex asset because its success depends on the surrounding environment, which is key in providing value for its owner.

Because of the importance of these identified factors, the teachings of system 10 fill an incredible void in the current marketplace. System 10 allows for any individual to assuage some of their concerns, as an accurate description and pricing of various spectrum can readily be identified. This could allow a given entrepreneur to determine how much money it will cost to buy a certain spectrum, and, further, what the resale market is going to most likely offer. This is critical for any person engaged in such a purchase. For example, if Investor A determines that he is willing to pay $30 million for spectrum rights in San Jose, Calif. for the $2.5 GHz range and the current bidding is at the $25 million range (this example assumes that there are a number of bidders in the $25 million range), then this bidder is likely to pay a premium of $5 million for his purchase.

The $5 million premium may not be ideal, but it does offer Investor A the ability to identify his risk: worst-case scenario being the loss of $5 million. This important measurable difference stands in contrast to previous systems that would only allow an individual to speculate about how much he was paying for a given spectrum purchase. More importantly, the exchange offered by system 10 offers a market that allows the buyer in this scenario to identify that he is assuming about $5 million in risk. Every investment in a given marketplace includes some amount of risk. What is tantamount in this scenario is that the buyer is made aware of his risk before his purchase. Thus, if the buyer were to purchase these spectrum rights and only realize that his funding (e.g., venture capitalists) were not willing to subsidize his company, then he could simply exit the investment through exchange platform 12. Such liquidity would offer an efficient marketplace for any persons seeking to deal in spectrum rights.

In accordance with one embodiment, a significant risk is also reduced with respect to compliance requirements of participating parties associated with a transaction. This could apply to all phases of the transactions: from pre-qualified registration requirements to follow-up addendum after the transaction has been completed. Both through the registration requirements and through the natural progression of the transaction, risk is reduced through a greater degree of timeliness and accuracy associated with information being provided to buyer 16 and seller 18. Additionally, such a thorough progression of specific steps, each of which ensure a high level of accuracy from participating parties, allow for enhanced satisfaction for marketplace participants. Such individuals can confidently execute their transactions knowing that miscellaneous regulatory and compliance requirements will be met. Thus, the comprehensiveness of the tendered information (having been collected and secured with accompanying diligence imparted by the present invention) forms a foundation from which participants can reasonably act in order to secure their transactions.

System 10 further offers a prospective buyer or seller a multilateral process that includes investigation, solicitation, negotiation, and execution of spectrum or tower rights. Qualified participants may search the comprehensive database 28 of geographic areas to identify the availability of the wireless spectrum and facilities. This permits any two entities to enter into a direct communication when a match exists between availability, facilities, and length of desired use between the parties. The efficiency of multilateral discussions among qualified buyers facilitates the confidence of market participants in identifying assets (and trading partners), and conducting timely negotiations of the rights to the desired spectrum.

Note that in describing FIGS. 2-14, an example is offered for purposes of demonstrating a single implementation of the present invention. In no way should such an example abrogate any of the rights and the privileges afforded to the appended claims of this patent application. In the example offered, an individual (John James) is described as navigating the process facilitated by the elements of FIGS. 2-14. Such an explanation need not restrict or constrain the expansive teachings and boundaries of the present invention: such rights being inalienable.

In the example of John James, John first sought to contact an exchange associated with spectrum rights via a website, and then to simply call an operator of the exchange in order to answer any other future questions. In our example, John James, who recently inherited a large sum of money ($30 million), seeks to start a broadband company in Indianapolis, Ind. John James has learned that the critical first step toward making his business plan come to fruition is the monumental purchase of spectrum, which supports his business plan.

FIG. 2 is a simplified schematic diagram of an example registration page that may be used in system 10 in accordance with an embodiment of the present invention. The registration page, provided for prequalification of buyers 16 and seller 18, facilitates active engagement in marketplace transactions. In addition, the registration page offers a pathway for separate eligibility criteria to be solicited. This could incentivize proprietary licensees, licensors, and other qualified participants to enter into secondary market transactions involving spectrum rights. Buyer 16 and seller 18 registration information may be submitted through an initial registration screen, as illustrated in FIG. 2, or provided in any other appropriate manner such as via a conventional mail system or via telephonic conversations with a representative of exchange platform 12.

In an example embodiment, John James has initiated the registration process of FIG. 2. A number of variables are solicited from John James such that one or more profiles 30 that correspond to John James may be initiated and properly stored in database 28. In this example, used for purposes of teaching only, John James is required to provide variables such as: a company name, address, decision making authority, contact information, the spectrum assets sought, the preference as to whether the spectrum will be bought, sold, or leased, the length of time for which the spectrum is sought, the desired frequencies from among a comprehensive list of spectrum, the geographic area to be included, and the type of spectrum architecture that will be employed. Various permutations of these variables are certainly within the broad scope of the present invention and may be based on particular needs.

The user profile information (included in profile 30) is important because it represents the information that a person is interested in receiving. For example, if John James decides not to pursue a broadband spectrum and instead opts for the 1700 MHz spectrum, his shift in interest can be reflected by his updated profile. Thus, he may be contacted by sellers, buyers, or agents when an opportunity presents itself that is associated with his chosen spectrum. Moreover, the profile information offers important contract information that can be used to contact John James about his bid for a certain spectrum, or to apprise him of a spectrum sale in adjacent markets. For example, John's profile information may include an e-mail address, which can be used to provide e-mail notifications and other marketplace updates for John. Exchange platform 12 is powerful in that it can be used to notify John James of any possible opportunity associated with his spectrum of choice. The allows for an interactive system that is constantly making John James aware of any available opportunity relating to his selected spectrum. The tendered architecture also provides an arrangement that solicits, and gathers (and later provides) information from one party such that a prospective counter-party (or other qualified participant) can be made aware of the presence of that participant. This helps to facilitate an optimal coordination between market participants that are mutually beneficial.

Once the information is entered through one or more registration screens, buyer 16 or seller 18 will either receive authorization to enter the marketplace, or they will not be permitted to enter the marketplace due to a failure to meet eligibility criteria for the type of transaction being contemplated. In certain cases, buyer 16 or seller 18 may be required to submit additional documentation. An administrator of exchange platform 12 may review the registration information and then send a customer enrollment agreement to the potential buyer 16 or seller 18. Note that, in general, a limited policing function can be provided for system 10, as certain individuals registering with exchange platform 12 may be duly investigated. Such an investigation is minimal, as it is a daunting task to actually verify each person's assets, liquidity, etc. Additional due diligence could be performed via the FCC, lawyers for both parties, and/or background investigations and could be a sub-part of any transaction executed via the offered spectrum exchange.

The customer enrollment agreement may be distributed to each potential buyer 16 and seller 18. The customer enrollment agreement is a standardized legal agreement that must be executed by a duly authorized corporate representative in order for the entity seeking pre-qualification to become a member of the exchange. The customer agreement may include provisions for non-circumvention to prevent information provided via the exchange to be used to enter into private transactions for the purpose of avoiding payment of contractually agreed commissions to exchange platform 12. The customer agreement may also be used to prohibit the possibility that such private transactions would not be disclosed to other qualified participants and, thus, make it non-compliant with FCC standards. As a corollary, such non-circumvention provisions may include the explicit agreement that all transactions entered into via exchange platform 12 are public transactions that will be fully disclosed to all qualified participants, regulatory authorities, and legally entitled parties. Upon receipt of a signed customer agreement, buyer 16 or seller 18 is then free to participate in transactions associated with rights related to wireless spectrums. Thus, after consummation of the customer enrollment agreement and after fulfillment of financial liquidity requirements, exchange platform 12 can configure a wireless spectrum account, including escrow accounts explicitly funded to support trading activity.

Continuing with our example associated with John James, John's registration information was received at a next location where it was suitably verified. This verification included a number of due diligence investigations because John's most recent history supported that he only had an annual income of approximately $31,000. From this point, an authorized person associated with exchange platform 12 sent John James a form agreement that binds him to certain conditions (e.g., that he is to be represented by the exchange to the FCC) and that offers a number of caveats for owners of exchange platform 12 (e.g., any misleading information provided during registration will subject John James to having his account canceled, that John James is to make no material misrepresentations to the exchange or to the FCC, etc.). Once John James' registration was reviewed and approved, John James was issued a user identification (ID) and a password (as illustrated in FIG. 3) that grants him access to exchange platform 12.

FIG. 3 is a simplified schematic diagram of an example log-in page that may be used in system 10. Once the requirements of exchange platform 12 are satisfied (having properly reviewed the tendered customer information) a user ID and password may be issued for qualified participants. The qualified participant can then enter the marketplace and be presented with the ability to transact business associated with spectrum and/or tower rights. Hence, either buyer 16 or seller 18 may now investigate and pursue market availabilities for the purchase, sale, or lease of spectrum rights or tower space. In general, it is ultimately up to the seller to strike the legal documents needed to firm up a sale or to make sure there is money in escrow to cover the bid. In other embodiments, this process is more automated.

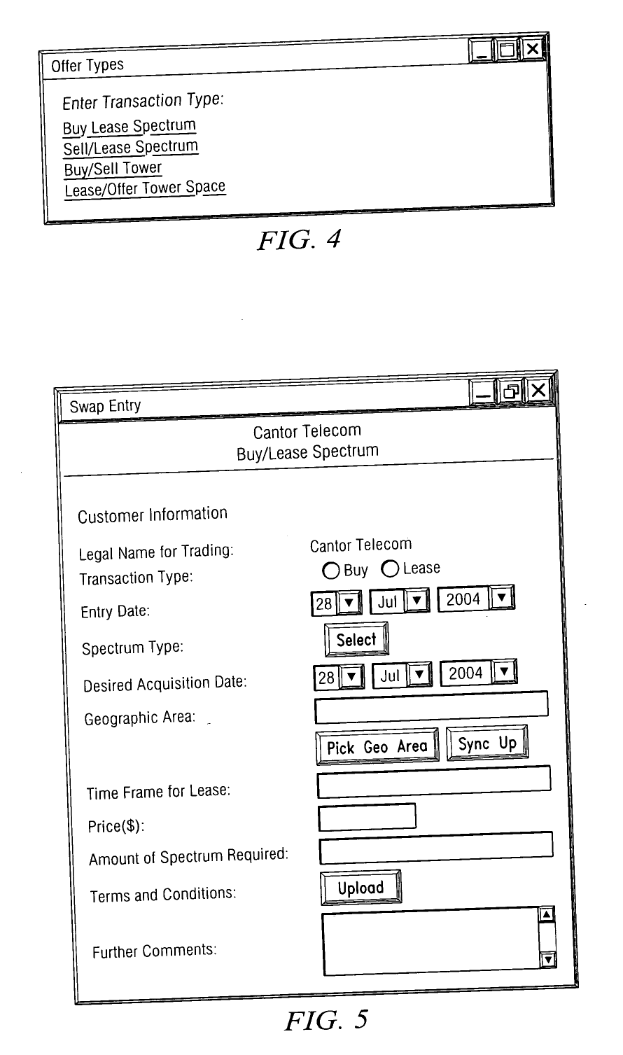

FIG. 4 is a simplified schematic diagram of an example transaction page that may be used in system 10. The qualified participant may make a selection pertaining to buying, selling, or leasing spectrum rights or tower space. Once the customer has made his selection, he may then be directed to another page that offers more specificity associated with his initial decision.

FIG. 5 is a simplified schematic diagram of an example asset description page that may be used in system 10. The screen page of FIG. 5 allows an end user to identify the date for the purchase, sale, or lease of the targeted asset. In addition, the page allows pricing information, terms and conditions, and any number of additional parameters to be selected. Note that such terms and conditions may be inclusive of any additional details, as the targeted commodity is considered to be a multidimensional asset. Such levels of complexity (e.g., tower attributes, power configurations, spectrum parameters, etc.) can easily be accommodated (and their delivery automated) by exchange platform 12. Any such technical descriptions could readily be part of the terms and conditions section, as such an expensive asset would universally merit supplemental technical descriptions and specifications. This screen page may further identify the technology that is being used, the desired acquisition date, the geographic area, and the type of spectrum frequency being sought or any other item (based on particular needs). In our example involving John James, he has simply entered his desired selection (i.e. a lease for spectrum) and he has now been forwarded to the next screen.

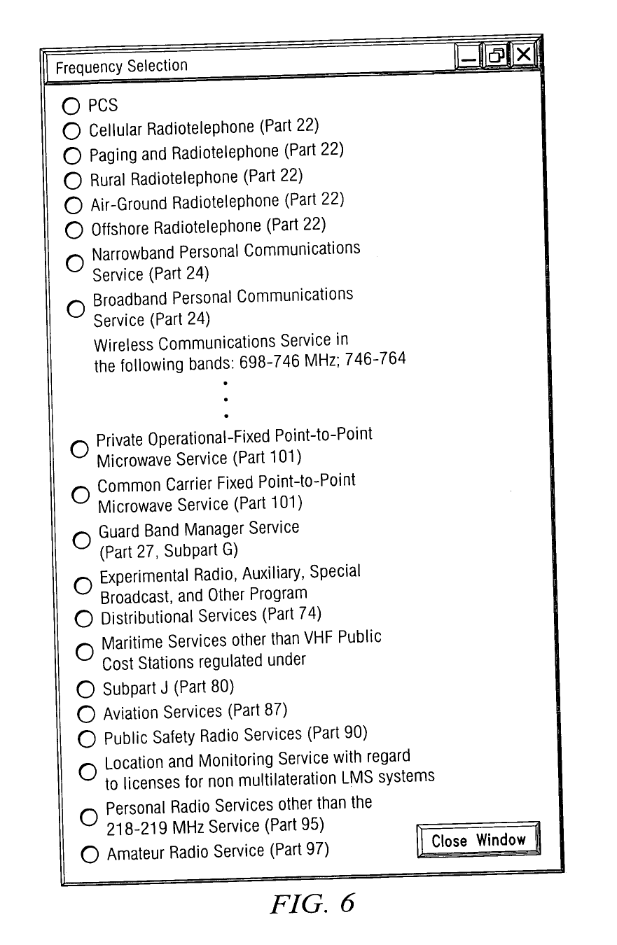

FIG. 6 is a simplified schematic diagram of an example frequency selection page that may be used in system 10 in accordance with an embodiment of the present invention. The example of FIG. 6 offers just one sampling of potential frequencies that may be auctioned off in cooperation with exchange platform 12. Continuing with our example involving John James, John is seeking to purchase broadband personal communications service (PCS) spectrum. (Note that this band is generally in the range of 1850-1990 MHz and is used for digital cellular phone service. Such technology is second-generation (2-G) and is dominated by companies such as AT&T, Cingular Wireless, and Sprint.) Once the frequency has been selected (using the “Select” button of FIG. 5, which then yielded the display of FIG. 6), John James may then choose his geographic area. By selecting the search button (e.g., identified as “Pick Geo Area” in FIG. 5), the user is presented with a map of the entire potential geographic area for which that user is qualified to engage in wireless spectrum activities. This is done as a complete embodiment that uses progressively higher resolution maps, up to and including satellite maps, with 100% visual coverage of associated terrain. This permits the most precise search possible for available facilities and spectrum.

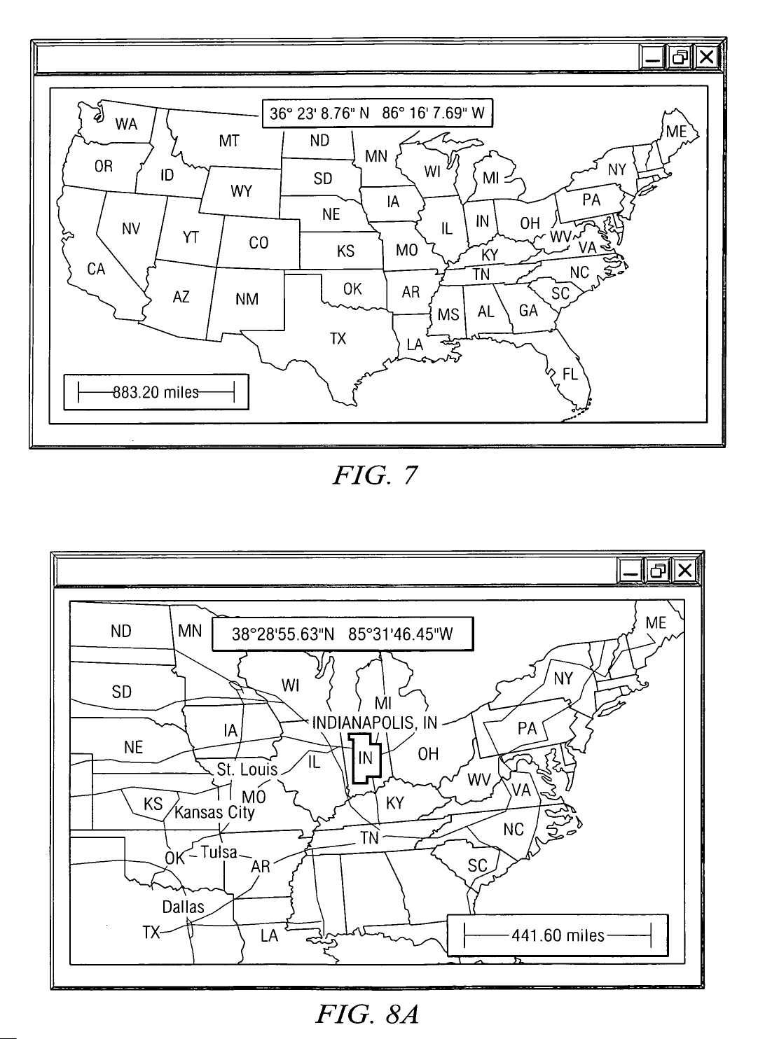

FIG. 7 is a simplified schematic diagram of an example mapping page that may be used in system 10. FIG. 7 includes longitudinal and latitude coordinates, as well as a key or scale to assist a given end user in measuring various distances or in selecting his target areas. The geographic area may be selected in conjunction with utilizing a complete geographic database (included as part of database 28 or provided separately as its own database in alternative embodiments) that can be searched by using either data entry tools or by clicking through a succession of geographic maps. Actual longitude and latitude points (or coordinates) could be input during such data entry. From these coordinates, an end user could be directed to that specific area from which he could perform any additional searching (e.g., searching for towers within a ten mile radius) where appropriate and based on particular needs.

In our example, John has decided to return to his hometown to open his broadband company; he decided to start his broadband business in Indianapolis, Ind. Once John James chooses the state of Indiana, John is forwarded to a next screen, which offers a more detailed map of the state of Indiana.

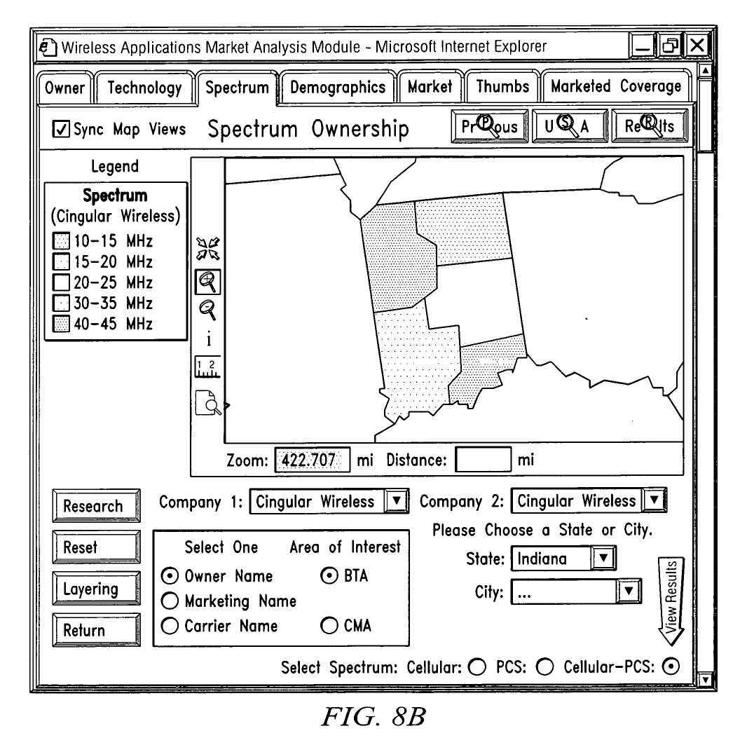

FIG. 8A is a simplified schematic diagram of a more detailed example mapping page that may be used in system 10. An additional representation (illustrated by FIG. 8B) could be provided in conjunction with FIG. 8A and include information such as: who owns which frequencies, how much of selected frequencies is being used, tower availability, how much infrastructure has been built, spectrum utilization (i.e. how many users are currently using the selected spectrum), and which competitors are operating in this region. The selected portions of FIG. 8B illustrate ownership rights in various areas in this example. Thus, in our example involving John James, John can readily identify what Cingular Wireless owns in any given area, how much telecommunications infrastructure has been built, and how many towers are present (and/or available) in Indianapolis, Ind. Hence, this can provide a complete solution in giving a full picture of what is going on in a given area. The highlighted and bolded region of FIG. 8A represents the geographical boundaries used by the FCC in auctioning spectrums in Indianapolis, Ind.

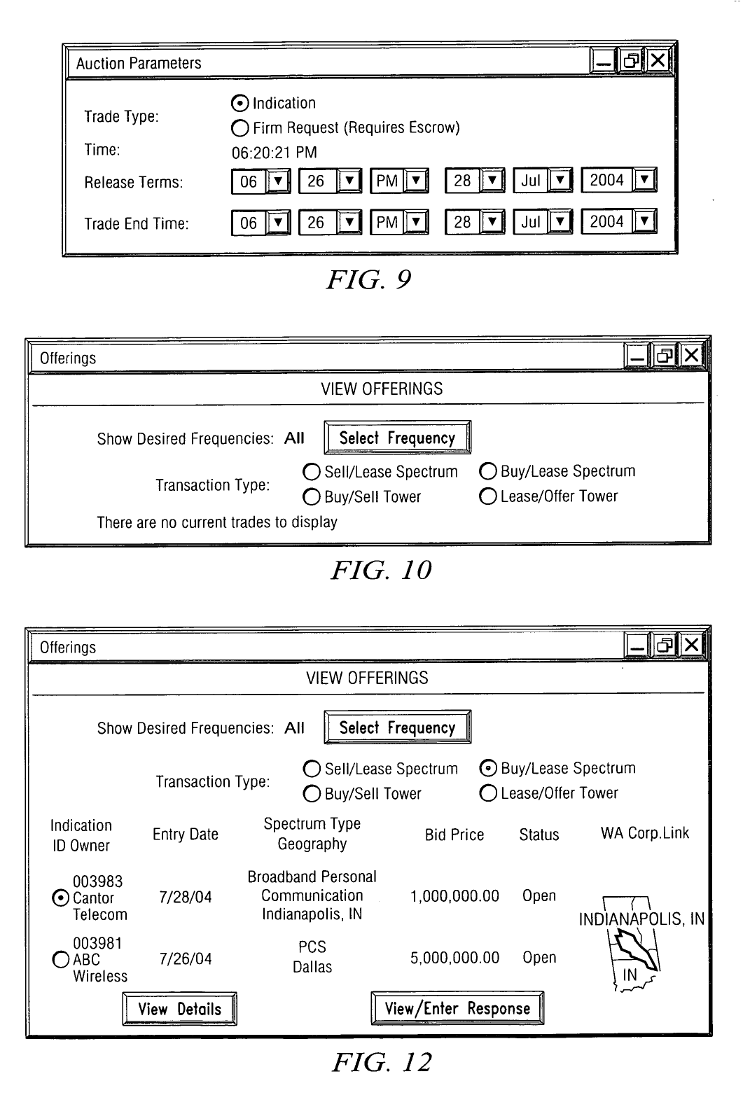

FIG. 9 is a simplified schematic diagram of an example auction parameter page that may be used in system 10. FIG. 9 illustrates the trade type (e.g., “indication of interest” or “firm” request, which generally requires escrow). Once an end user has selected the trade type, the release, and end term times can then be input. These parameters designate the exact times that the selected trade will be initiated and when the selected trade will expire. In our example involving John James, John has elected that his offer will only be good for about three months.

FIG. 10 is a simplified schematic diagram of an example offerings selection page that may be used in system 10. FIG. 10 may be used to elect between selling, buying, or leasing spectrum or tower space. In the example involving John James, John has elected to lease spectrum rights.

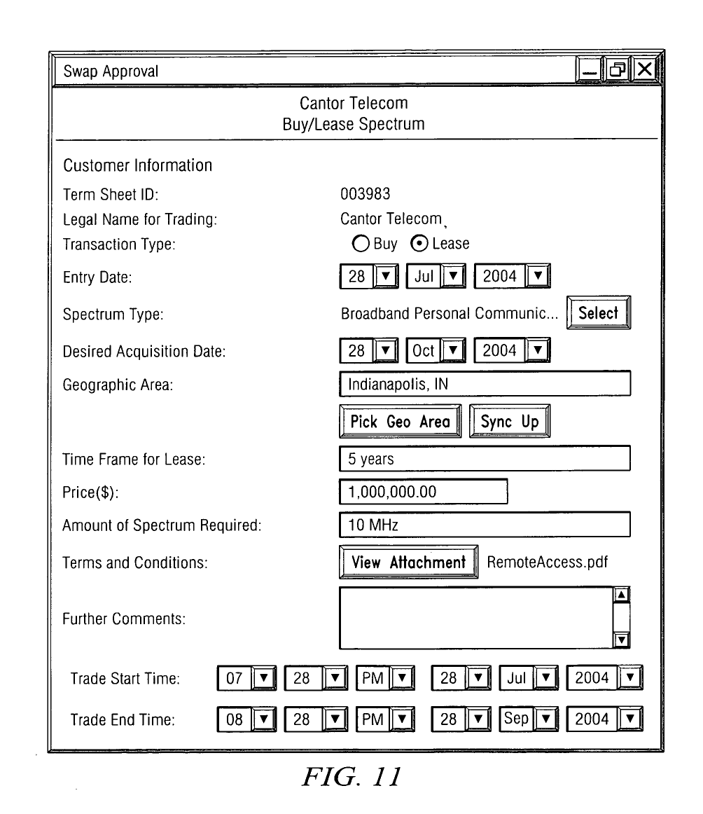

FIG. 11 is a simplified schematic diagram of an example trade submission and/or approval page that may be used in system 10. FIG. 11 is a reflection of FIG. 5, although a number of parameters have already been designated. From this point, an end user is prompted to input terms and conditions (e.g., via a PDF form or similar file) such that the selected trade will reflect those designated terms and conditions. It is expected that these terms and conditions will be provided in conjunction with one or more lawyers representing an end user. The terms and conditions can be appended as part of the agreement involving the selected wireless spectrum rights and, thus, bind the end user accordingly. Full terms and conditions may include the decision to buy or to lease, the type of frequency, the basic trading area, and whether local, municipal, or national governments are involved. In addition, a “Further Comments” section may also be provided (as is illustrated in FIG. 11) in order to supply any additional information (e.g., regarding foreign ownership, or designated entity status), or other information required for consideration of the transaction and for regulatory approvals.

After the terms and conditions have been properly loaded by a given participant, then the indications are uploaded so that they are searchable by all qualified participants for any arbitrary period of time. The advertisement of interest or of a solicitation may be received by any who can fill the order or who have expressed interest in receiving such types of information. Counterparties may then review and search the terms and conditions and, thereafter, respond by initiating advanced negotiations. Browsing through the tendered terms and conditions could permit the parties to choose their points of action. Moreover, such an opportunity could be used by any person to make necessary adjustments to the proposed terms and conditions in order to reflect their own business directives. All communications (e.g., via e-mail) may be recorded (e.g., on a central register), providing a complete audit record of all activities. Such records may be used for purposes of consummating the transaction, as well as any subsequent compliance or regulatory requirements as promulgated by the FCC. The e-mail option may be provided within system 10 in order to satisfy the FCC standard that disclosures associated with such transactions be fair, transparent, and effective.

FIG. 12 is a simplified schematic diagram of an example offerings page that may be used in system 10. FIG. 12 reflects the case where exchange platform 12 has retrieved the results requested by John James. The results include a geographical display that correlates to the selected spectrum. John now understands the availability of the PCS spectrum in Indianapolis, Ind., and further, the current prices for selected spectrum in those areas. If nothing else, John James is now informed about his potential future purchase of spectrum. In a best case scenario, John has identified available PCS spectrum that he can afford and use as a cornerstone for building his broadband company in Indianapolis, Ind. In a worse-case scenario, John understands that this market is heavily dominated by large telephone companies, that tower space is limited, and that he may be better off bidding in other areas in Indiana that are not as competitive or expensive. John could also look at other frequencies (e.g., such as 2.5 GHz and use 24 GHz for backhaul) and generate a query to the tower owners for space and/or tower availability.

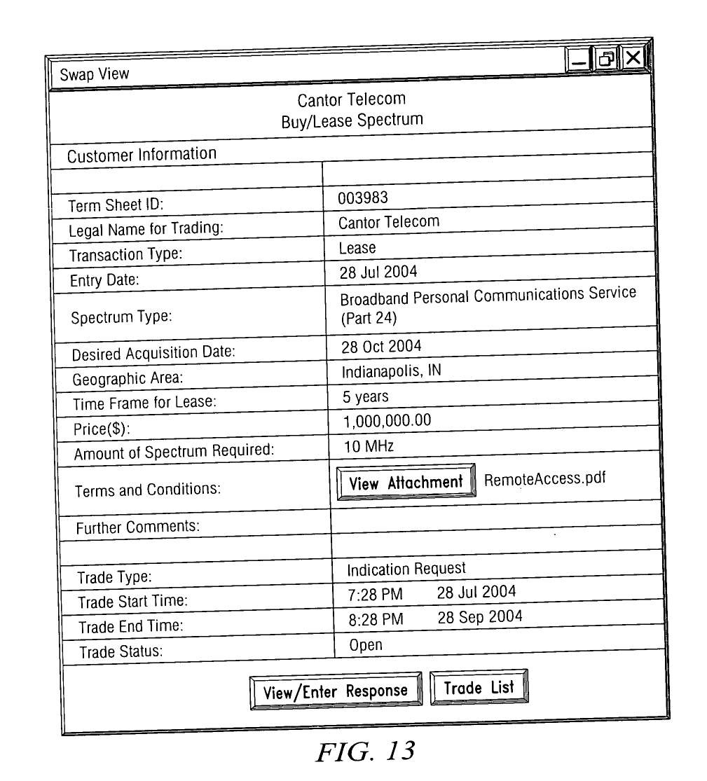

FIG. 13 is a simplified schematic diagram of an example completion page that may be used in system 10. The completion page may include all of the parameters input by John James, as well as a term sheet number and the status of the transaction. Once entering a firm indication scenario, in order to complete a transaction according to the agreed terms and conditions, monies deposited in the qualified user's trading account can be escrowed by system 10, whereby the parties can release full terms and conditions to each other to ensure full compliance. The parties to the particular transaction may then be asked to review and to confirm the agreed terms and conditions. To finalize the transaction, the first party involved in the transaction may select an “accept” icon, and the second party may also select an “accept” icon. The two counterparties may then receive notification of an executed trade in the agreed-upon spectrum. The acceptances constitute a legal commitment to trade spectrum, pursuant to the signed terms and conditions gathered by exchange platform 12.

Once firm acceptances are exchanged between the participants, notification (and potentially details of the transaction) may be released to all market participants (e.g., within postings of trades and indications of interest or via direct e-mail to their e-mail address of record, or through voice messages). This e-mail would offer a transparent indication of a price for spectrum: subject to the conditions in that particular trade. Expert users of the architecture would then have the capability, using marketplace historical data and general assumptions, to compare the transaction price with similar terms and conditions for the same or for other geographic areas. This would assist any given user in an effort to determine the current market price in other geographic areas of interest and, further, to ascertain a fair estimate for that selected spectrum. Note that any such disclosures associated with transactions would be in compliance with a corresponding regulatory agency (e.g., the FCC, Ofcom, the EU, etc.). Certain agencies may be more liberal or more strict in their disclosure protocols. Exchange platform 12 is adaptable in that it could readily accommodate any such practices.

Once the confirmation e-mail is received, the parties to the transaction may have the electronic capability to directly access the agreed terms and conditions, and, further, to generate first stage documents preparatory for key exhibits to be incorporated into the signed contract that will eventually be submitted to the FCC's streamlined approval process. The signed contract is an event that may be audited by exchange platform 12, which receives an electronic copy of the transaction. In addition, exchange platform 12 may record contract values, determine commission charges based on the customer agreement, and store all such information in database 28. FCC filings may be contemporaneous, but not necessarily explicitly linked via exchange platform 12.

Thus, as is readily evident by the above-identified example, the present invention brings together a comprehensive database 28 of available inventory with complete granularity. Database 28 also includes a comprehensive list of qualified participants. Database 28 can be used in order to facilitate and expedite real-time communications between all qualified participants, as well as provide verifiable documentation of all communications, while assisting in regulatory approval. This may be achieved through the creation of first-stage legal documents as addenda and through framework exhibits to final contracts.

It is again noteworthy to identify that the above implementation of the present invention is an example embodiment and only used for purposes of discussion and teaching. Exchange platform 12 may be applied to a host of other spectrum and tower space transactions. Moreover, some of the steps illustrated of FIGS. 2-14 may be changed or deleted where appropriate and additional steps may also be added. These changes may be based on specific communication system architectures or particular networking arrangements or configurations and do not depart from the scope or the teachings of the present invention.

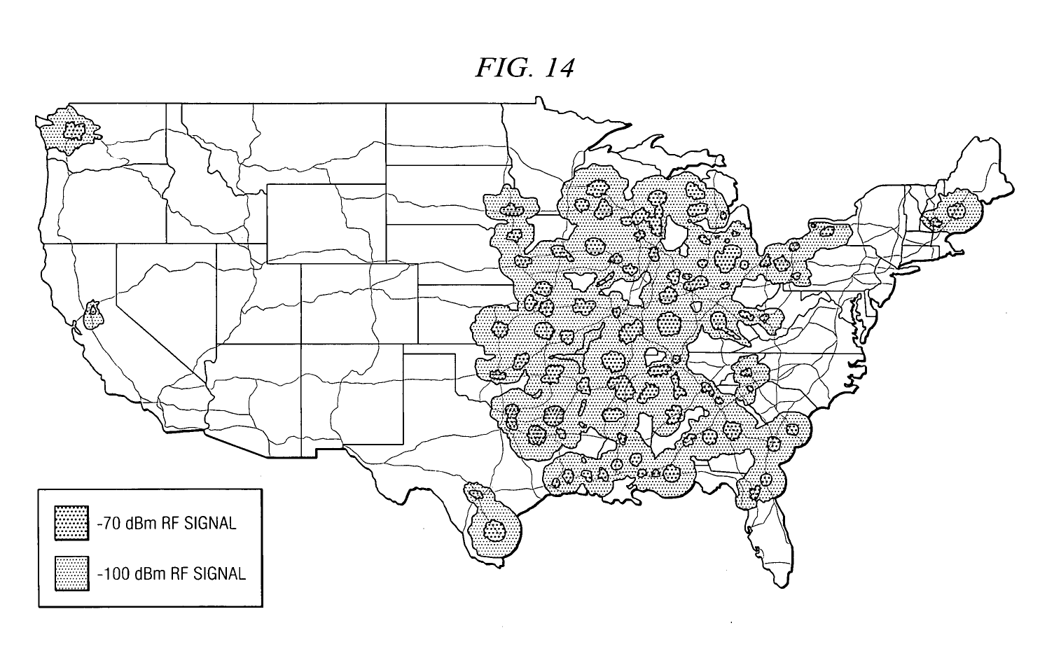

FIG. 14 is a simplified schematic diagram that can be used to describe another aspect of the present invention. Before evaluating that FIGURE more thoroughly, a brief interlude is offered for purposes of teaching and in order to better guide and inform the audience. The digital paradigm is a superior broadcasting solution, as it delivers a high-quality signal that can easily traverse long distances. For example, as television stations here in the U.S. switch from analog to digital, a single channel (e.g. Channel #38) can be split into multiple segments (e.g. Channel #38: 1, 2, 3, and 4). The underlying issue here is bandwidth. As can readily be inferred, there is some ‘dead air’ in some of these slots, which are not being utilized to their full capacity. The traditional content is still being delivered via one slot of Channel #38 in our example, and perhaps slot #2 is being used for high-definition broadcasts. However, slots #3 and #4 represent additional slots of spectrum bandwidth that can be leveraged in order to deliver content to millions of televisions, digital receiver boxes with DVR, VOD & PPV, laptops, or PDAs, etc.

The present invention can utilize exchange platform 12 from which the aforementioned spectrum assets can be bought or sold to market participants. The exchange can offer time slots for sale, where the time slots can be broken down to hours, days, minutes, or seconds. For example, exchange platform 12 can offer the precise spectrum assets associated with Channel #38, slot #4: on Thursday Mar. 29, 2006 from 6:00 PM to 10:00 PM. Either a small entity or a large content provider could see this offering and recognize the opportunity to broadcast their content in this slot.

It should be noted that there is no need for either of these potential purchasers to incur large capital expenditures for the purpose of broadcasting their content. Neither party would be obligated to purchase a transmitter, or to ensure that households have televisions for watching this particular content. As long as the terms and the price are met, the purchaser can buy this spectrum and have his content broadcast over the particular slot at the designated time.

In other instances, big companies may seize the buying opportunity offered by exchange platform 12 and purchase large blocks of available spectrum. These companies could proceed to build their own network (e.g. deploy a series of digital transmitters) or these companies could simply resell these spectrum assets in a market environment.

In practice, this concept allows a given entity (e.g. a filmmaker) to avoid striking deals with large conglomerates (e.g. the American Broadcasting Company (ABC) or Sprint Mobile). By leveraging existing technology, a given entity can, in effect, build his own network and/or secure a forum in which to display his work. In a broad sense, the proposed spectrum solution involves the sale of virtual spectrum, not necessarily the underlying physical asset. Hence, within the realm of existing infrastructures and transmission/reception techniques, there is the inherent capability of auctioning specific spectrum rights.

In cases where the spectrum is available, this solution would offer a viable (and relatively cheap) alternative to negotiating with broadcasting companies for ‘air time’ in a conventional sense. For example, in today's currency terms, about $2 million could secure the spectrum rights to the entire state of Hawaii. In addition, for about $500,000, a simple digital transmitter could be deployed that would offer the end user all broadcast rights for a channel (e.g. Channel #38). Now, the end user could broadcast to every digital television in this coverage area. Note that there is specific spectrum available in certain markets, where some markets are more expensive or competitive than others. Additionally, there are certain frequencies that may trigger some compliance issues with the SEC. However, the eminent and prevalent theme is that the current existing infrastructure is capable of facilitating broadcasting or digital data protocols, as outlined herein for both one-to-many and for two-way communications.

More particularly, FIG. 14 illustrates the contours associated with a number of cities in the U.S. The circles in the map represent a coverage area for selected channels. In this example, Channel #38 is being highlighted. A given person, who may be interested in purchasing spectrum assets, could click onto the selected channel and see all pertinent information. For example, a person could see the population of the target city, its demographics, its anticipated viewership for selected programs, and its Nielsen ratings for any previously aired program. Other relevant data could readily be accessed from this screen. The purchasers and sellers could use this information to make informed/educated decisions about the valuation of a given time slot/spectrum.

As more end users bring their assets on-line, more market opportunities will allow a given entity to expand their coverage POP counts. For certain businesses, the focus could be on delivering content market-by-market. Spectrum and tower buyers can easily be made aware of these specific available spectrum assets. From there, buyers can initiate their own processes in evaluating the assets with their own business, technical, and legal resources. The operators of exchange platform 12 are truly creating a more efficient marketplace in bringing buyers and sellers together. Participants could include wireless/landline operators, municipalities, content providers, investors, tower companies, content aggregators, cable companies, WISP's, government agencies, etc.

In alternative embodiments, exchange platform 12 can be used to secure rights in WiMax applications. For example, a service provider could construct a network that could yield a speed of 2 to 3 megabits over prolonged periods. In essence, this service provider has a pipe and an interested person could avail themselves to this technology. Thus, a subscriber service company (e.g. having 400,000 subscribers) could advertise to their customers that this new speed can be available to them for a fee. Such a subscriber entity could offer enhanced delivery of simple data, video (e.g. movies), large-files, audio (e.g. music), or streaming content. A content provider could then make bids on this bandwidth and, subsequently, deliver their content over this pipe. In this sense, a content exchange is being created for buyers and suppliers. Virtual spectrum (i.e. the associated rights thereto) is being swapped in open market conditions.

WiMax/WiBro standards will help utilize spectrum and create more pipes for the consumer. This technology could allow a given service provider to acquire certain channels and become an alternate major broadcaster/distributor of digital/analog wireless content using the latest technology and emerging business models.

In still other alternative embodiments, software-defined radio devices could be used to detect what spectrum is currently available. These devices are equipped with electronics that allow them to recognize the surrounding spectrum, which can be leveraged for any given application. Once the available spectrum is identified, the device is configured to direct the end user to a series of questions that allow for the immediate purchase of virtual bandwidth/spectrum. For example, the end user may only need five (5) minutes of air time or five (5) gigabits of memory for a specific photograph, or video. This would allow for a real-time purchase of the necessary spectrum and bandwidth. The mobile device (e.g. laptop, PDA, cellular telephone, Blackberry, Treo, etc.) would offer a price-point mechanism for the immediate transmission of data.

In yet other embodiments, exchange platform 12 can be used to secure adverting space using the protocols outlined above. For example, IBM could make a bid on certain advertising spectrum that is available during the Super Bowl. Up until the airing of the Super Bowl, IBM could resell these rights to any other party, or simply broadcast their commercials as originally planned.

Alternatively, the end user could set up a digital mobile system in which the end user can broadcast to mobile devices (e.g. cellular telephone, laptop, PDA, Blackberry, Treo, etc.). In yet other embodiments, a conversion from analog televisions (i.e. terrestrial televisions) to digital televisions (e.g. high-definition televisions) can be executed. Hence, all models that consume or that rely on spectrum for their applications could benefit from the teachings of the present invention. These could include, for example, streaming one-way data (IP), two-way high speed Internet communications, wVOIP, WiMax, etc., or any type of digital data costs, any type of content broadcasts, any type of two-way transmissions, any type of mobile Internet transmissions, etc.

As described above, the elements and operations listed in FIGS. 1-14 may be achieved with use of system 10 in any number of contexts and applications. Accordingly, communications capabilities, data processing features and elements, suitable infrastructure, adequate personnel and management, and any other appropriate software, hardware, or data storage objects may be included within system 10 to effectuate the tasks and operations of the elements and activities associated with wireless spectrum or tower rights. Accordingly, FIG. 1 provides only one example of a suitable processing and communications platform from which transactions may be executed.

Although the present invention has been described in detail with reference to particular embodiments in FIGS. 1-14, it should be understood that various other changes, substitutions, and alterations may be made hereto without departing from the sphere and scope of the present invention. For example, although the preceding FIGURES have referenced a number of screen shots associated with a website, any suitable interfaces may readily be substituted for such a website and, similarly, benefit from the teachings of the present invention. Additionally it should be noted that although the example embodiments have described an example exchange platform 12, any suitable entity could facilitate transactions involving spectrum or tower rights. For example, personnel (capable of accessing database 28) may readily implement such an architecture without departing from the teachings of system 10. Moreover, a number of example frequency choices have been illustrated by the previous FIGURES. However, in no way should any person construe these examples as exhaustive. The proffered examples reflect tradable frequencies, as currently mandated by the FCC. System 10 could readily be used in conjunction with additional spectrum choices as they are made available to market participants. Such permutations are clearly within the broad space of the present invention.

Numerous other changes, substitutions, variations, alterations, and modifications may be ascertained to one skilled in the art and it is intended that the present invention encompass all such changes, substitutions, variations, alterations, and modifications as falling within the spirit and scope of the appended claims. In order to assist the United States Patent and Trademark Office (USPTO) and additionally any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of filing hereof unless the words “means for” or “step for” are specifically used in the particular claims; and (b) does not intend by any statement in the specification to limit this invention in any way that is not otherwise reflected in the appended claims.

What is claimed is:

1. An exchange platform, comprising:
a database operable to store information associated with at least one spectrum asset that includes virtual rights to be afforded to a holder of the spectrum asset, wherein the database is further operable to communicate with an end user that provides data to the exchange platform, and wherein the database can be accessed by the end user in order to identify the spectrum asset.

2. The exchange platform of claim 1, wherein the database is operable to store transactional information associated with the spectrum asset, the transactional information being recorded and stored such that it may be accessed in order to be audited.

3. The exchange platform of claim 2, wherein the spectrum asset is associated with a one-to-many or a two-way communication involving content.

4. The exchange platform of claim 1, wherein the database is further operable to store information associated with at least one slot of a channel associated with the spectrum asset.

5. The exchange platform of claim 1, wherein the exchange platform further comprises a processor operable to execute one or more electronic tasks to be performed in conjunction with facilitating a transaction relating to the spectrum asset or the selected tower space allocation.

6. The exchange platform of clam 1, wherein the database is further operable to store a profile associated with the end user, the profile including a selected one or more variables selected from a group consisting of:
a) contact information associated with the end user;
b) a company name associated with the end user;
c) an address associated with the end user;
d) decision making authority of the end user;
e) spectrum assets or tower space sought by the end user;
f) a preference as to whether spectrum rights will be bought, sold, transferred, or leased;
g) a length of time for which spectrum rights or tower spaces are sought;
h) a geographic area sought for spectrum rights; and
i) a type of telecommunications architecture that is associated with spectrum rights sought by the end user.

7. The exchange platform of claim 1, wherein the database includes one or more geographic representations corresponding to the spectrum asset.

8. The exchange platform of claim 1, wherein the database is operable to provide information associated with a selected one or more of characteristics that are included in a group consisting of:
a) ownership of spectrums in a selected geographic region;
b) quantification of selected spectrums that are being used in the selected geographic region;
c) tower availability in the selected geographic region;
d) quantification of infrastructure that has been built in the selected geographic region;
e) competitors operating in the selected geographic region;
f) demographics associated with the selected geographic region;
g) user activity associated with spectrum utilization within the selected geographic region; and
h) individual or group e-mail contact information that is associated with one or more persons who own spectrums, towers, or tower space allocations.

9. The exchange platform of claim 1, wherein the spectrum asset comprises a time slot that can be broken down to hours, days, minutes, or seconds.

10. The exchange platform of claim 1, wherein the database includes data about the spectrum asset, the data being associated with a population of a city, demographics of the city, anticipated viewership for selected programs in the city, or Nielsen ratings for any previously aired program in the city.

11. The exchange platform of claim 1, wherein the end user is a content provider.

12. The exchange platform of claim 1, wherein the spectrum asset is associated with broadcast rights for specific time slots in a digital environment.

13. The exchange platform of claim 1, wherein the exchange platform can communicate with software-defined radio devices, which can be used to detect what spectrum is currently available and to enable a price-point mechanism for the spectrum asset.

14. The exchange platform of claim 1, wherein the spectrum asset is associated with a digital mobile system set up in which the end user can broadcast content to mobile devices by using the spectrum asset that is purchased or transferred.

15. The exchange platform of claim 1, wherein the spectrum asset is used to broadcast advertising data at a given time slot.

16. The exchange platform of claim 1, wherein the spectrum asset is used to broadcast data associated with WiMax applications.

17. A method for facilitating a transaction involving spectrum assets and an exchange platform, comprising:
storing information associated with at least one spectrum asset in a database, the spectrum asset including virtual rights to be afforded to a holder of the spectrum asset; and
communicating with an end user that provides data, wherein the database can be accessed by the end user in order to identify the spectrum asset.

18. The method of claim 17, further comprising:
storing transactional information relating to the spectrum asset, the transactional information being recorded and stored such that it may be accessed in order to be audited.

19. The method of claim 17, wherein the transactional information relates to a purchase, a sale, a transfer, or a lease of the spectrum asset.

20. The method of claim 17, wherein the database is further operable to store information associated with at least one slot of a channel associated with the spectrum asset.

21. The method of claim 17, wherein the database includes data about the spectrum asset, the data being associated with a population of a city, demographics of the city, anticipated viewership for selected programs in the city, or Nielsen ratings for any previously aired program in the city.

22. The method of claim 17, wherein the spectrum asset is associated with broadcast rights for specific time slots in a digital environment.

23. The method of claim 17, wherein the exchange platform can communicate with software-defined radio devices, which can be used to detect what spectrum is currently available and to enable a price-point mechanism for the spectrum asset.

24. The method of claim 17, wherein the spectrum asset is associated with a digital mobile system set up in which the end user can broadcast content to mobile devices by using the spectrum asset that is purchased or transferred.

25. The method of claim 17, wherein the spectrum asset is used to broadcast advertising data at a given time slot.

26. The method of claim 17, wherein the spectrum asset is used to broadcast data associated with WiMax applications.

27. A system for facilitating a transaction involving spectrum assets, comprising:
means for storing information associated with at least one spectrum asset in a database, the spectrum asset including virtual rights to be afforded to a holder of the spectrum asset; and
means for communicating with an end user that provides data, wherein the database can be accessed by the end user in order to identify the spectrum asset.

28. The system of claim 27, further comprising:
means for storing transactional information relating to the spectrum asset, the transactional information being recorded and stored such that it may be accessed in order to be audited.

29. The system of claim 27, wherein the transactional information relates to a purchase, a sale, a transfer, or a lease of the spectrum asset.

30. The system of claim 27, wherein the database is further operable to store information associated with at least one slot of a channel associated with the spectrum asset.

31. The system of claim 27, wherein the database includes data about the spectrum asset, the data being associated with a population of a city, demographics of the city, anticipated viewership for selected programs in the city, or Nielsen ratings for any previously aired program in the city.

32. The system of claim 27, wherein the spectrum asset is associated with broadcast rights for specific time slots in a digital environment.

33. The system of claim 27, wherein the exchange platform can communicate with software-defined radio devices, which can be used to detect what spectrum is currently available and to enable a price-point mechanism for the spectrum asset.

34. The system of claim 27, wherein the spectrum asset is associated with a digital mobile system set up in which the end user can broadcast content to mobile devices by using the spectrum asset that is purchased or transferred.

35. The system of claim 27, wherein the spectrum asset is used to broadcast advertising data at a given time slot.

36. The system of claim 27, wherein the spectrum asset is used to broadcast data associated with WiMax applications.
